(19) United States
(12) Patent Application Publication
(10) Pub. No.: US 2012/0178399 A1
(43) Pub. Date: Jul. 12, 2012

(54) INTERACTIVE SYSTEM

(75) Inventor: Chao-Tung Yang, Hsinchu (TW)

(73) Assignee: LINGO LIMITED, Kowloon (HK)

(21) Appl. No.: 13/042,464

(22) Filed: Mar. 8, 2011

(30) Foreign Application Priority Data
Jan. 7, 2011 (TW) 100200403

(51) Int. Cl. H04B 1/16; H02J 7/00; G06F 3/00

(52) U.S. Cl. 455/337; 715/705; 320/114

(57) ABSTRACT

An interactive system is provided. The interactive system includes a handheld device and an insertion device. An interactive application program is embedded into the handheld device. The insertion device has a protective case for protecting the handheld device, and the insertion device also has a slave circuit, where the insertion device does not have a screen or a keypad. When the interactive application program is activated by a user through putting the handheld device into the insertion device, the handheld device will display an interactive graphical user interface so as to guide the user to set the insertion device, and the handheld device controls the functions of the slave circuit.

### CROSS-REFERENCE TO RELATED APPLICATION

This application claims the priority benefit of Taiwan application serial no. 100200403, filed Jan. 7, 2011. The entirety of the above-mentioned patent application is hereby incorporated by reference herein and made a part of this specification.

### BACKGROUND OF THE INVENTION

1. Field of the Invention

The invention generally relates to an interactive system, and more particularly, to an interactive system which adds additional functions to a handheld device.

2. Description of Related Art

Conventional handheld devices such as smart phones, personal digital assistants (PDAs), portable digital multimedia players, tablet computers are now developed to be lighter, thinner, and easier to carry around. As these handheld devices are light and compact, protective cases (or protective jacket) are needed for protecting outer layers to prevent accidental damages or breakages.

Generally, protective cases fabricated with rubber, metal, or plastic are often adopted to protect handheld devices. These protective cases are merely used to protect the outer layers of handheld devices and have no other special circuit properties.

Referring to FIG. 1, FIG. 1 shows a protective case embedded with a charger in conventional technology. When the handheld device is placed into the protective case to connect with a charging socket in the protective case, a mobile power supply then charges the handheld device.

Referring to FIG. 2, FIG. 2 illustrates a protective case having an embedded charger of a conventional technology. This protective case has an LED light in the back to display a charging status of backup power. In another protective case having an embedded charger, a charging switch on the protective case is turned on when charging is needed.

Dongles are designed to provide additional functions to handheld devices. Referring to FIG. 3, FIG. 3 illustrates a dongle with functions of a radio. This dongle has a screen and a keypad. When the dongle having functions of a radio is inserted into a connection port of the handheld device, the dongle is capable of charging power from the handheld device to provide electric energy required by the dongle. However, a user can not control the dongle by operating the handheld device and has to operate through the keypad on the dongle, where the channel is display on the screen of the dongle. Moreover, the method adopting the dongle has a flaw, that is, the dongle damages the connection port of the handheld device easily and can not protect the handheld device. Further, the device utilizing the dongle then has a larger volume. Since the dongle does not have a battery, the electric energy of the handheld device is further consumed. In other words, the electric energy of the handheld device is consumed faster than normal. The adoption of the dongle is thus inconvenient.

### SUMMARY OF THE INVENTION

The invention is directed to an interactive system capable of solving the problems involved in the conventional technology.

In an exemplary embodiment of the invention, an interactive system including a handheld device and an insertion device is provided. The handheld device has an interactive application program embedded therein. The insertion device has a protective case for protecting the handheld device and includes a slave circuit. When the handheld device is placed into the insertion device to activate the interactive application program, the handheld device displays an interactive graphical user interface so as to guide a user to set the insertion device and the handheld device controls a plurality of corresponding functions of the salve circuit.

In an exemplary embodiment of the invention, the slave circuit includes a connector, a radio frequency integrated circuit, a demodulator/decompressor, and a digital to analog converter. The connector is coupled to the handheld device for the handheld device and the insertion device to have a two-way communication. The radio frequency integrated circuit is configured to receive a radio frequency signal and convert the radio frequency signal to an intermediate frequency signal. The demodulator/decompressor is coupled between the radio frequency integrated circuit and the connector. The demodulator/decompressor receives the intermediate frequency signal transmitted by the radio frequency integrated circuit and demodulates and decompresses the intermediate frequency signal through the control of a central processing unit CPU of the handheld device. The digital to analog converter is coupled to the demodulator/decompressor. A decompressed digital signal is played after being converted by the digital to analog converter, or a decompressed digital signal is transmitted to a display panel or a speaker of the handheld device for playing.

In an exemplary embodiment of the invention, the slave circuit further includes an audio video interface output port, a high definition multimedia interface output port, or a digital visual interface output port, and the decompressed digital signal is converted by the digital to analog converter and played by the audio video interface output port or the decompressed digital signal is played by the high definition multimedia interface output port or the digital visual interface output port.

In an exemplary embodiment of the invention, the radio frequency integrated circuit and the demodulator/decompressor are one of digital television (TV) chips, digital audio broadcasting (DAB) chips, and global positioning system (GPS) chips, or a combination thereof.

In an exemplary embodiment of the invention, the radio frequency integrated circuit is one of a frequency modulation (FM) broadcasting chip and an amplitude modulation (AM) broadcasting chip.

In an exemplary embodiment of the invention, when the radio frequency integrated circuit and the demodulator/decompressor are digital TV chips, the interactive graphical user interface guides the user to set the playing of a digital TV.

In an exemplary embodiment of the invention, when the radio frequency integrated circuit and the demodulator/decompressor are DAB chips, the interactive graphical user interface guides the user to set the playing of a digital audio broadcast.

In an exemplary embodiment of the invention, when the radio frequency integrated circuit and the demodulator/decompressor are GPS chips, the interactive graphical user interface guides the user to set the map guiding or the positioning in a GPS system.

In an exemplary embodiment of the invention, when the radio frequency integrated circuit is an (FM) broadcasting chip, the interactive graphical user interface guides the user to set the playing of an FM broadcast.

In an exemplary embodiment of the invention, when the radio frequency integrated circuit is an AM broadcasting chip, the interactive graphical user interface guides the user to set the playing of an AM broadcast.

In an exemplary embodiment of the invention, the slave circuit includes a charger and the handheld device controls the charger to charge the handheld device.

In an exemplary embodiment of the invention, when the slave circuit comprises an infrared chip, the interactive graphical user interface guides the user to set the transmission of a remote.

In an exemplary embodiment of the invention, the handheld device is a smart phone, a personal digital assistant (PDA), a portable digital multimedia player, or a tablet computer.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the invention.

FIG. 1 illustrates a conventional protective case embedded with a charger.

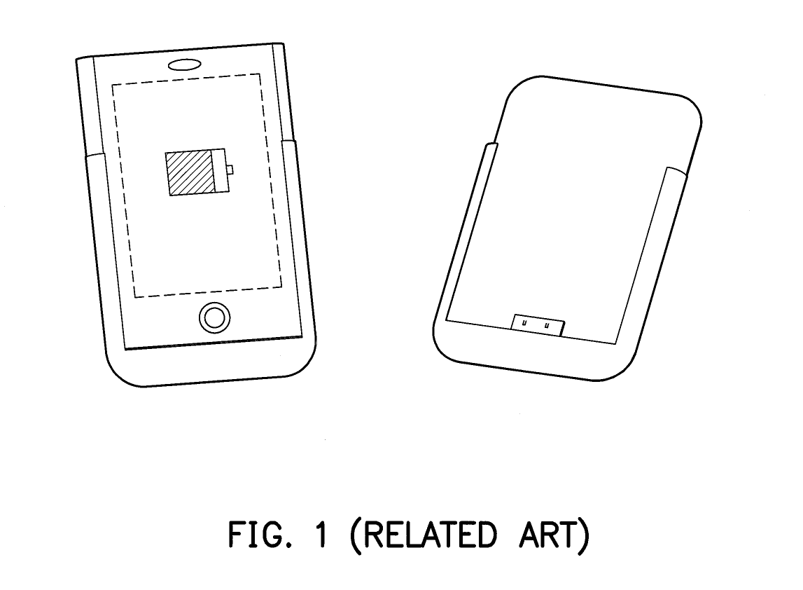

FIG. 2 illustrates another conventional protective case embedded with a charger.

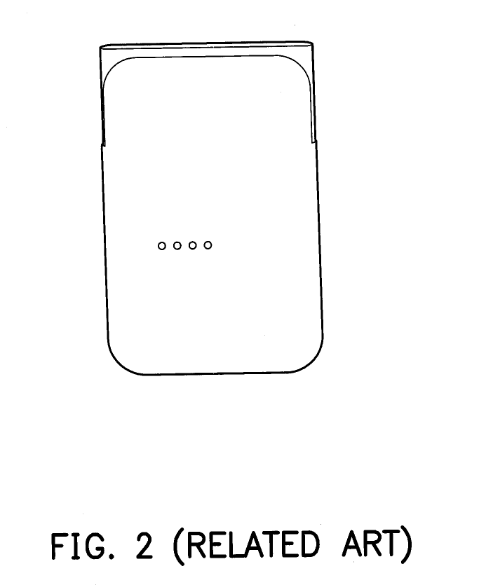

FIG. 3 shows a conventional dongle with functions of a radio.

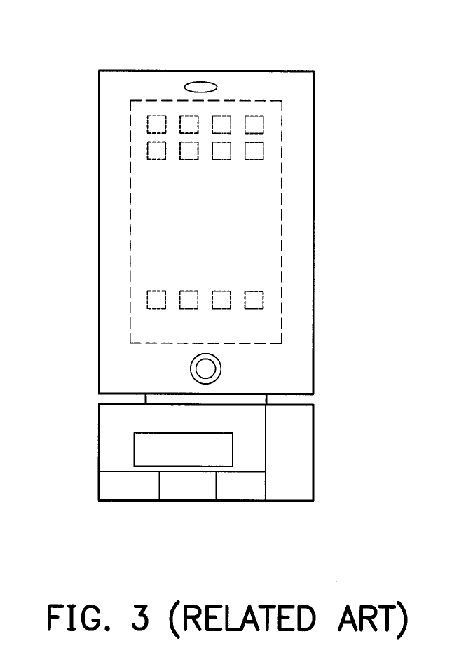

FIG. 4 is a schematic diagram illustrating an interactive system according to a disclosed embodiment.

FIG. 5 is a circuit block diagram illustrating an interactive system according to a disclosed embodiment.

FIG. 6 is a schematic diagram illustrating a connection between an interactive system and an external device according to a disclosed embodiment.

### DESCRIPTION OF EMBODIMENTS

An interactive system protects a handheld device and adds new functions thereto. A user thus then experiences the convenience brought by the additional functions of the handheld device.

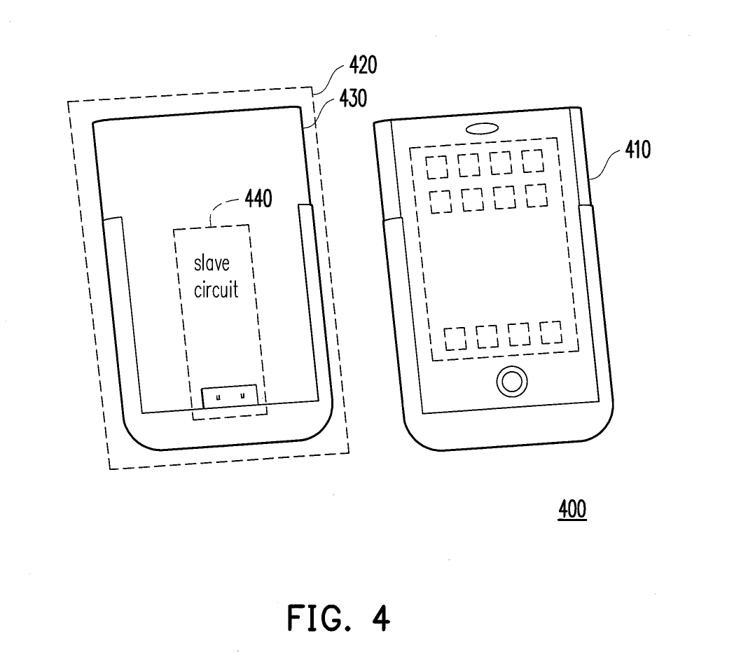

FIG. 4 is a schematic diagram illustrating an interactive system according to a disclosed embodiment. An interactive system 400 includes a handheld device 410 and an insertion device 420. The handheld device 410 is a smart phone, a personal digital assistant (PDA), a portable digital multimedia player, or a tablet computer. The handheld device 410 has an interactive application program embedded therein. The insertion device 420 has a protective case 430 (or a protective jacket) for protecting the handheld device 410. The protective case 430 is fabricated with rubber, metal, or plastic. The insertion device 420 has a slave circuit 440. The insertion device 420 does not include a screen or a keypad. The operation and the display of the insertion device 420 are performed through the handheld device 410.

Accordingly, when the user places the handheld device 410 into the insertion device 420, the insertion device 420 protects an outer casing of the handheld device 410. The handheld device 410 activates the interactive application program and the screen of the handheld device 410 displays an interactive graphical user interface so as to guide the user to set various functions of the insertion device 420. Herein, the handheld device 410 controls various functions of the slave circuit 440. Moreover, the handheld device 410 and the slave circuit 440 have a two-way communication therebetween to transmit signals or messages.

Although the embodiments aforementioned provided possible types of the interactive system in the invention, persons of common knowledge in the art should understand that different manufacturers provide different designs of the insertion device 420. The application of the invention is thus not limited to the possible types listed above. In other words, the spirit of the invention is met as long as the handheld device 410 controls the functions and settings of the insertion device 420 having the protective case. Few more embodiments are provided below for persons of common knowledge in the art to further understand the spirit of the invention and implement the invention.

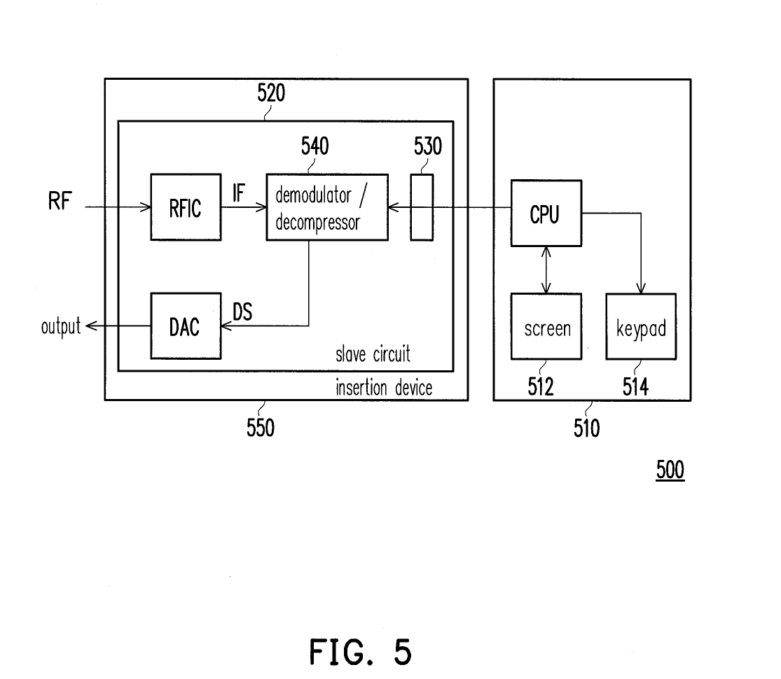

FIG. 5 is a circuit block diagram illustrating an interactive system according to a disclosed embodiment. An interactive system 500 includes a handheld device 510 and an insertion device 550. The insertion device 550 has a protective case (not shown in FIG. 5, can be referred to the protective case 430 in FIG. 4) and a slave circuit 520. The insertion device 550 does not include a screen or a keypad. The handheld device 510 has an interactive application program embedded therein. When the user places the handheld device 510 into the insertion device 550, the handheld device 510 activates the interactive application program and a central processing unit CPU executes the interactive application program. Thereafter, a screen 512 of the handheld device 510 displays the interactive graphical user interface so as to guide the user for setting various functions and playing methods of the slave circuit 520. The user operates the functions of the slave circuit 520 through the screen 512 and a keypad 514 of the handheld device 510. The keypad 514 can be a hardware keypad or a software keypad actualized with a touch screen. The screen 512 can be an ordinary panel or a touch panel and the type of the screen 512 or the keypad 514 is not limited here.

In the present embodiment, the slave circuit 520 is embedded in the protective case (not shown). The slave circuit 520 includes a connector 530, a radio frequency integrated circuit RFIC, a demodulator/decompressor 540, and a digital to analog converter DAC. The connector 530 is coupled to the handheld device 510 for transmitting signals or messages with a two-way communication. The demodulator/decompressor 540 is coupled between the RFIC and the connector 530. The digital to analog converter DAC is coupled to the demodulator/decompressor 540. The radio frequency integrate circuit RFIC is configured to receive a radio frequency signal RF and convert the radio frequency signal RF to an intermediate frequency signal IF. The demodulator/decompressor 540 receives the intermediate frequency signal IF transmitted from the frequency radio integrated circuit RFIC. Moreover, the demodulator/decompressor 540 demodulates and decompresses the intermediate frequency signal IF through the control of the central processing unit CPU of the handheld device 510. Herein, a decompressed digital signal DS is played after being converted by the digital to analog converter DAC, or a decompressed digital signal DS is transmitted to a screen 512, a speaker, or an earphone (not shown) of the handheld device 510 for playing.

It should be noted that additional function circuits can be added to the framework of the interactive system 500 and the function circuits are still controlled by the handheld device 510. For example, the slave circuit 520 includes a charger (not shown), the handheld device 510 controls the charger to charge the handheld device 510, such that a mobile power supply can be utilized by the handheld device 510. For example, the slave circuit 520 includes an infrared (IR) chip (not shown), the handheld device 510 controls the IR chip and utilizes the interactive system as a remote control. The interactive graphical user interface guides the user to set the transmission of the remote control.

It should be noted that the radio frequency integrated circuit RFIC and the demodulator/decompressor 540 can be designed according to actual demands and the application scope there is not limited herein. For instance, the radio frequency integrated circuit RFIC and the demodulator/decompressor 540 are one of digital television (TV) chips, digital audio broadcasting (DAB) chips, and global positioning system (GPS) chips, or a combination thereof. When the radio frequency integrated circuit RFIC and the demodulator/decompressor 540 are digital TV chips, the interactive graphical user interface guides the user to set the playing of a digital TV. When the radio frequency integrated circuit RFIC and the demodulator/decompressor 540 are DAB chips, the interactive graphical user interface guides the user to set the playing of a digital audio broadcast. When the radio frequency integrated circuit RFIC and the demodulator/decompressor 540 are GPS chips, the interactive graphical user interface guides the user to set the map guiding or the positioning in a GPS system.

When the radio frequency integrated circuit RFIC is a frequency modulation (FM) broadcasting chip, the interactive graphical user interface guides the user to set the playing of an FM broadcast. When the radio frequency integrated circuit RFIC is an amplitude modulation (AM) broadcasting chip, the interactive graphical user interface guides the user to set the playing of an AM broadcast.

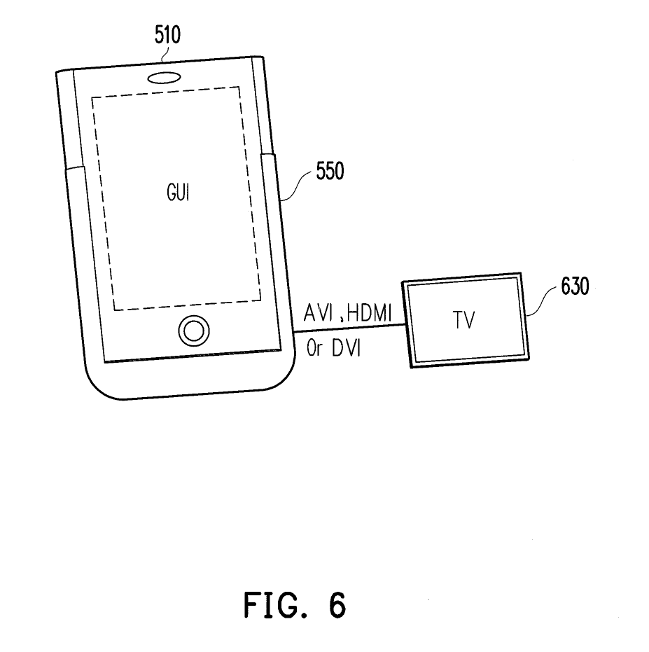

FIG. 6 is a schematic diagram illustrating a connection between an interactive system and an external device according to a disclosed embodiment. Referring to FIGS. 5 and 6, in the present embodiment, an output port is further disposed in the slave circuit 520. The output port is an audio video interface (AVI) output port, a high definition multimedia interface (HDMI) output port, or a digital visual interface (DVI) output port. The image or sound output is transmitted to an external device 630 through an audio video interface AVI, a digital visual interface DVI, or a high definition multimedia interface HDMI for playing. For example, the handheld device 510 displays an interactive graphical user interface GUI. As the insertion device 550 is disposed with an output port, the user can operate the interactive graphical user interface GUI and play with the external device 630. Herein, the external device 630 is not limited to TVs. Persons in the technical field of the invention can use different types of output ports and external devices 630 according to various design demands. It should be noted that the decompressed digital signal DS can be transmitted to the digital to analog converter DAC and output to the earphone. Or, the decompressed digital signal DS can be converted into a specific format digital signal directly to be played by the HDMI output port or the DVI output port (an additional line can be connected to the HDMI/DVI output port when needed in FIG. 5).

In summary, in the interactive system of the invention, as the handheld device can control various functions and settings of the insertion device having the protective case, the insertion device not only protects the outer layer of the handheld device, but also provides additional functions thereto. Moreover, the interactive system of the invention can solve the disadvantages of the conventional protective case which does not include other function circuits. The disadvantages of the dongle having function circuits are also solved as the connection port of the handheld device is prevented from been damaged and the outer layer of the handheld device is protected. Further, the insertion device does not include a screen or a keypad and the fabrication cost thereof is thus reduced. The dimension of the insertion device is close to that of the handheld device, so that the handheld device and the insertion device can be combined for convenient use. Hence, the interactive system not only protects the handheld device, but also provides additional functions. A user thus then experiences the convenience brought by the additional functions of the handheld device.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An interactive system, comprising:
a handheld device having an interactive application program embedded therein; and
an insertion device, comprising:
a protective case configured to protect the handheld device; and
a slave circuit,
wherein the insertion device does not comprise a screen or a keypad, and when the handheld device is placed into the insertion device to activate the interactive application program, the handheld device displays an interactive graphical user interface so as to guide a user to set the insertion device and the handheld device controls a plurality of corresponding functions of the salve circuit.

2. The interactive system as claimed in claim 1, wherein the salve circuit comprises:
a connector coupled to the handheld device for the handheld device and the insertion device to have a two-way communication;
a radio frequency integrated circuit (RFIC) configured to receive a radio frequency signal and convert the radio frequency signal to an intermediate frequency signal;
a demodulator/decompressor coupled between the RFIC and the connector, wherein the demodulator/decompressor receives the intermediate frequency signal transmitted by the RFIC and demodulates and decompresses the intermediate frequency signal through a control of a central processing unit of the handheld device; and
a digital to analog converter coupled to the demodulator/decompressor, wherein a decompressed digital signal is played after being converted by the digital to analog converter or a decompressed digital signal is transmitted to a display panel or a speaker of the handheld device for playing.

3. The interactive system as claimed in claim 2, wherein the slave circuit further comprises an audio video interface output port, a high definition multimedia interface output port, or a digital visual interface output port, and the decompressed digital signal is converted by the digital to analog converter and played by the audio video interface output port or the decompressed digital signal is played by the high definition multimedia interface output port or the digital visual interface output port.

4. The interactive system as claimed in claim 2, wherein the RFIC and the demodulator/decompressor are one of digital television (TV) chips, digital audio broadcasting (DAB) chips, and global positioning system (GPS) chips, or a combination thereof.

5. The interactive system as claimed in claim 4, wherein when the RFIC and the demodulator/decompressor are digital TV chips, the interactive graphical user interface guides the user to set a playing of a digital TV.

6. The interactive system as claimed in claim 4, wherein when the RFIC and the demodulator/decompressor are DAB chips, the interactive graphical user interface guides the user to set a playing of a digital audio broadcast.

7. The interactive system as claimed in claim 4, wherein when the RFIC and the demodulator/decompressor are GPS chips, the interactive graphical user interface guides the user to set a map guiding or a positioning in a GPS system.

8. The interactive system as claimed in claim 2, wherein when the RFIC is a frequency modulation (FM) broadcasting chip, the interactive graphical user interface guides the user to set a playing of an FM broadcast.

9. The interactive system as claimed in claim 2, wherein when the RFIC is an amplitude modulation (AM) broadcasting chip, the interactive graphical user interface guides the user to set a playing of an AM broadcast.

10. The interactive system as claimed in claim 1, wherein the slave circuit comprises a charger and the handheld device controls the charger to charge the handheld device.

11. The interactive system as claimed in claim 1, wherein when the slave circuit comprises an infrared chip, the interactive graphical user interface guides the user to set a transmission of a remote control.

12. The interactive system as claimed in claim 1, wherein the handheld device is a smart phone, a personal digital assistant, a portable digital multimedia player, or a tablet computer.
